(19) United States
(12) Patent Application Publication
(10) Pub. No.: US 2003/0194473 A1
(43) Pub. Date: Oct. 16, 2003

(54) PROCESS AND APPARATUS FOR PRODUCING DIETARY FIBER PRODUCTS

(76) Inventors: BRUCE K. REDDING JR., BROOMALL, PA (US); JEROME HARDEN, PHILADELPHIA, PA (US)

Correspondence Address: MARTIN SAVITZKY ESQ, SYNNESTVEDT & LECHNER, 1101 MARKET STREET 26TH FLOOR, PHILADELPHIA, PA, 19107

(21) Appl. No.: 09/360,262

(22) Filed: Jul. 26, 1999

Related U.S. Application Data
(63) Continuation-in-part of application No. 08/988,758, filed on Dec. 11, 1997, now abandoned.
Application No. 08/988,758 is a continuation of application No. 08/696,614, filed on Aug. 14, 1996, now abandoned.

(51) Int. Cl. A23L 3/00

(52) U.S. Cl. 426/238; 426/615; 426/519; 426/463; 426/507

(57) ABSTRACT

Dietary fibers have their properties modified by applying a shock wave to a dispersion of the fibers in a fluid carrier. Pressure from a piston, in either a single or a series of compressive strokes or pulses exerted on the dispersion applies the shock wave. Increasing the effect of cavitation caused by the shock wave can enhance the modified properties of the fibers. The resulting pressure treated dietary fiber exhibits reduced calories, higher insoluble fiber content, reduced moisture absorption properties, and greater uniformity from batch to batch.

### CROSS-REFERENCE

This is a continuation-in-part of U.S. application Ser. No. 08/988,758 filed Dec. 11, 1997, which is a continuation of U.S. application Ser. No. 08/696,614 filed Aug. 14, 1996, both of which are titled “Dietary Fiber Products and Process and Apparatus for Producing Same” by Bruce K. Redding, Jr. and Jerome Harden, which applications are incorporated by reference as if fully set forth herein.

### BACKGROUND OF THE INVENTION

The invention relates to dietary fibers and more particularly to novel dietary fiber products and a process for producing it. Dietary fibers are used in a variety of food applications as both a means to reduce overall fat and calorie content for the ultimate food product and as a bulking agent replacement for products with reduced sugar or sweeteners. Used as a fat replacement, dietary fibers are employed as a fat mimic, approximating the mouth feel and texture of fat while affording a lower calorie alternative. As a bulking agent, dietary fibers are employed in efforts to reduce sugar and other sweeteners especially from baked goods such as snack food, cakes, pies and bread products. In such products having a reduced sugar content, a bulking agent is used to return the desired mass, texture and mouth feel to the product.

Dietary fibers are usually fibers that are derived from corn, wheat, cellulose, oats, or other natural grains. Generally, a dietary fiber is high in insoluble (i.e., indigestible) fiber content, ideally low in calories and low in fat content. Most dietary fibers offer great promise as an improved dietary additive to food products, but there are also several drawbacks.

Dietary fibers tend to absorb many times their weight in moisture; requiring longer bake times for baked goods incorporating such fiber ingredients. High water absorbing fibers require more machining time, i.e., time required for mixing and blending, and may produce a baked product that requires special packaging. Standard packaging is usually not effective with baked products incorporating dietary fibers because such fibers absorb large amounts of moisture.

Many dietary fibers also exhibit high oil absorption and retention properties, making their use in breaded coatings and mixes that are applied to fried foods a main source of absorbed fat and calories. Newer dietary fibers derived from corn or starch also provide very high calories, much the same as found in various starches.

The uniformity of dietary fiber features and properties often varies significantly from batch to batch and they are therefore not reliable in many processed food products.

Accordingly it is an object of the invention to provide improved dietary fibers in which at least some of these drawbacks are reduced.

It is an object of this invention to provide improved dietary fibers which exhibit modified water absorption properties to improve the use of such fiber in baked goods and for other applications. These properties may improve product machining, packaging, product cost and taste and mouth perception features.

It is an additional object of this invention to provide a means of reducing the fat content of the dietary fiber-containing food mixtures, as well as the oil, and fat, absorption and retention of bake mixes, batters and breaded coatings for fried foods by incorporating such modified dietary fibers into such food mixtures.

A further object is to improve the mouth feel of dietary fibers by in some cases increasing the water absorption of dietary fibers.

A further object is to increase the total dietary fiber content of dietary fiber products, which may be achieved, by increasing the total content of soluble and insoluble fiber or by increasing only the insoluble or indigestible component of treated dietary fiber. Furthermore, an increase in total dietary fiber may be used to reduce the calculated nutritional calorie content of the treated dietary fiber product for USDA labeling purposes.

A further object includes the improvement of baked and fried foods, by increasing their dietary functionality, through the addition of treated dietary fibers.

It is another object to provide a process for producing the above-mentioned improved fibers.

These and other objects are achieved in accordance with the invention as follows.

### SUMMARY OF THE INVENTION

The present invention relates to the use of high-pressure pulses applied to dietary fibers. More particularly, this invention relates to a process for modifying the properties of a particulate dietary fiber material comprising dispersing said particulate material in a liquid media, applying an abrupt pressure change to said particulate material in said liquid media, and recovering said modified fiber material. The present invention is capable of modifying fibers properties such as increased or reduced water absorption, reduced oil absorption, reduced oil retention, higher insoluble fiber content, reduced calories, reduced fat content and also provide a more uniform dietary fiber from batch to batch.

### BRIEF DESCRIPTION OF THE DRAWINGS

For further details, reference is made to the discussion that follows, in light of the accompanying drawings, wherein:

FIG. 1 is a diagrammatic illustration of the process for modifying dietary fibers in accordance with the invention involving the use of filtration.

FIG. 2 is an overall illustration of an apparatus for carrying out the process of dietary fiber modification according to this invention.

FIG. 3 is a more detailed illustration of the piston component of the pressure treatment apparatus of FIG. 2, showing the use of cavitation enhancers within the compression chamber.

FIG. 4 is a diagram of the baffled chamber component of the pressure treatment apparatus; and

FIG. 5 is a diagram of a baffle ring used in the baffled chamber component of the pressure treatment apparatus.

FIG. 6 is an enlarged view of the compression chamber illustrated in FIG. 3.

FIG. 7 is a top plan view of the flow cavitation enhancers according to the present invention.

FIG. 8 is a side view of the reflecting cavitation enhancer according to the present invention.

### DETAILED DESCRIPTION OF THE INVENTION

The pressure pulse is applied to the original dietary fibers, comprising a range of particle sizes, while they are in suspension, or dispersed in a slurry, in a given liquid media, or in a totally dissolved state, with the pressure being applied in the form of an abrupt pressure pulse induced by mechanical means. The liquid media may be water, an aqueous solution containing desired components, alcohol or some other organic solvent.

The abrupt pressure increases will sometimes be referred to herein as “pressure shock waves”. However, it is recognized that they may not really fit the theoretical definition of “shock waves”.

Such abrupt pressure increases, or pressure shock waves, are believed to transmit energy in three basic forms: high compression forces; heat via friction; and cavitation.

Studies of cavitation show that the heat produced during a cavitation effect can be very high, if only for a short period of time. Without intending to be bound by this explanation, Applicants theorize that pressure shock waves applied to a dispersion (e.g., slurry containing dietary fibers) can produce a modified form of dietary fibers through the effects of the heat energy caused by cavitation and the compressive forces produced by the pressure shock wave application. The present invention converts conventional (commercially available) dietary fiber, subjects it to a shock treatment, and produces a modified dietary fiber, exhibiting properties not previously obtainable.

Experiments described below have clearly demonstrated that such modified dietary fibers are indeed produced in accordance with the present invention and that these exhibit the following modified properties:

Reduction in water absorption and/or oil absorption properties.

Increase in water absorption and/or oil absorption properties.

Increase in the proportion of insoluble fibers.

Decrease of fat content.

Reduction of calories that may be reported on nutritional labels.

Greater uniformity between production batches.

A preferred embodiment of this invention is a process to reduce the water holding capacity and oil retention properties of dietary fibers selected from the group including dietary cellulose and wheat fibers, comprising preparing a suspension of said fibers in a liquid media, applying an abrupt pressure change greater than 13,000 psi to about 100,000 psi to said suspension and recovering a modified fiber having said reduced properties.

Another preferred embodiment is a process to increase the water holding capacity and oil retention properties of dietary fibers selected from the group including dietary soy, wheat bran, oat and oat hull fibers, comprising preparing a suspension of said fibers in a liquid media, applying an abrupt pressure change greater than 13,000 psi to about 100,000 psi to said suspension and recovering a modified fiber having said increased properties.

A further aspect of the present invention is a process to prepare a dietary fiber material having water absorption properties that are resistant to change due to temperature increases incurred during food processing comprising preparing a suspension of said fibers in a liquid media, applying an abrupt pressure change greater than 13,000 psi to about 100,000 psi to said suspension and recovering a modified fiber having said resistant properties.

Another aspect of the present invention is a process to increase the total dietary fiber content of a dietary fiber material comprising preparing a suspension of said fibers in a liquid media, applying an abrupt pressure change greater than 13,000 psi to about 100,000 psi to said suspension and recovering a modified fiber having said resistant properties.

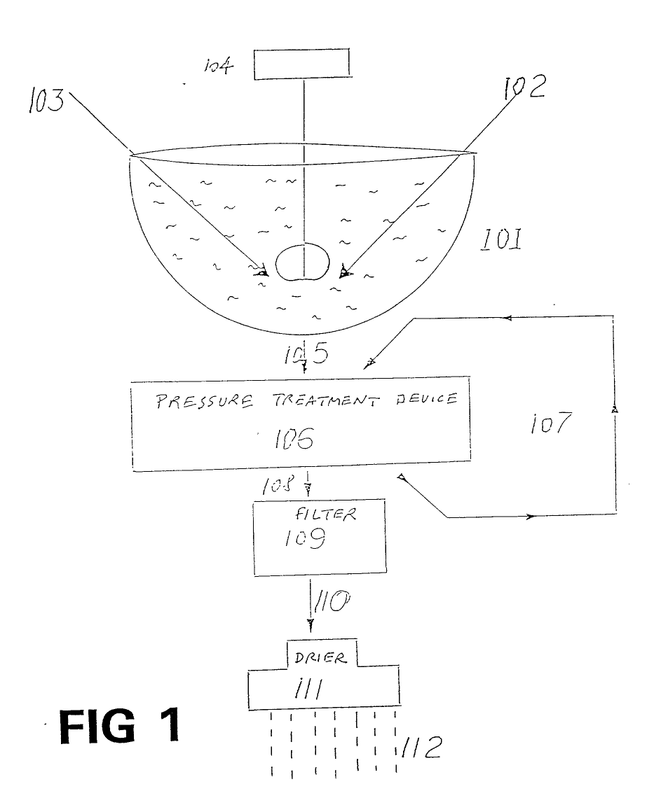

FIG. 1 shows the process of the invention in a flow-diagram format. In this Figure, a treatment vessel 101 contains a fluid carrier material 103 (e.g., water or an organic solvent), to which are added raw dietary fiber material 102. Agitation provided by a mixer 104 turns this mixture into slurry 105. Depending on the fluid carrier chosen and the type of raw dietary fibers added, the dietary fibers are either dispersed throughout or dissolved into the slurry 105. Once mixed, the fiber slurry 105 is delivered to pressure treatment device 106. The slurry may be applied in a heated, ambient or chilled state. In a preferred embodiment, the pressure treatment device 106 applies a single pressure treatment to the fiber slurry. If desired, the slurry 105 may be subjected to multiple cycles of pressure treatment through a repetition of the single treatment process. Such repetition is indicated by arrow 107.

The pressure treatment consists of the application of a single, or continuously recurring pressure shock waves to the slurry 105. The pressure treatment is measured in applied or compressive pressure as a function of the time period the pressure is applied to the slurry 105. The pressure levels can be as low as 1 psi to over 90,000 psi from the equipment provided for test purposes. Time duration's range from 0.001 to 1 full second, with most treatment time periods being in the range of 0.1 to 0.25 seconds. Preferred pressure levels are from about 13,000 psi to about 100,000 psi, with the more preferred being between about 40,000-psi to about 90,000 psi.

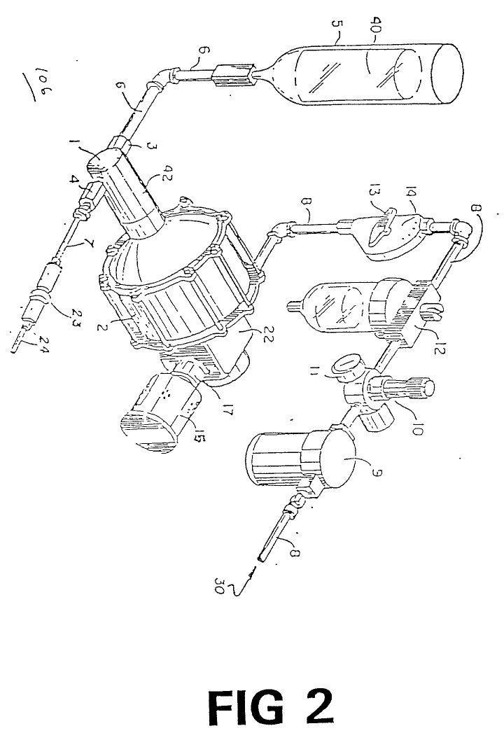

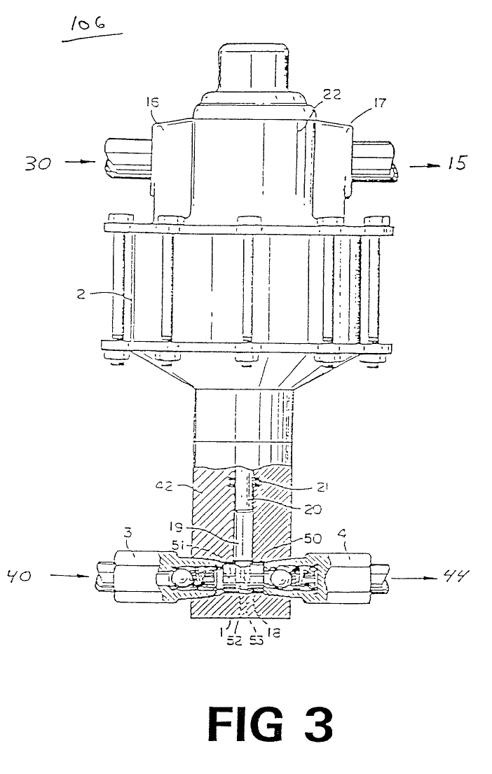

Pressure is applied in the preferred embodiment via a piston pressure applicator as shown in FIGS. 2 and 3. However other designs are possible for the application of the pressure treatment, such as ones using multiple pistons for pressure application.

Referring again to FIG. 1, pressure-treated fiber slurry 108 exits the pressure treatment device 106. A pump can be used to move the slurry through the present process. If desired, the slurry 108 may be pumped back into the pressure treatment device 106 where it is subjected to additional pressure treatments as illustrated in the re-cycle loop 107. After the pressure treatment process, the slurry 108 is directed to a filtration device 109 which acts to remove the solid, pressure-treated particulate material from the slurry, generally producing a “wet cake” 110. The “wet cake” 110 is then delivered to the appropriate drying mechanism 111 which usually yields a pressure-treated dietary fiber product 112 in the form of a powder. The wet cakes 110 may be delivered to the drying device manually or by an automatic conveying device.

The drying device 111 may be an oven, spray drier, vacuum dryer, fluid bed dryer, freeze dryer, flash dryer or any other mechanism which will remove the residual moisture 103 from the pressure treated fiber, resulting in a dry powder form 112.

Depending on the application, the pressure-treated fiber slurry 108 may be delivered directly to the drying device 111 without filtering. Also, the pressure-treated slurry may be suitable for commercial application as a pressure treated fiber remaining in a slurry or suspension form.

A preferred embodiment of an apparatus for modifying dietary fibers in accordance with the invention is shown in FIGS. 2, 3, 4 and 5.

Referring now to FIG. 2, the pressure treatment device 16 includes a pump 2 that drives a reciprocating piston 20 for exerting a pressure pulse on the material which is pumped through the apparatus. A reservoir 5 is placed at the input of the pressure treatment device 106.

The reservoir 5 is usually not heated but may be in some cases by heating coils, not shown. The reservoir 5 may also be stirred to allow the dietary fibers to be dispersed prior to passing through the apparatus. In the illustrated embodiment, the slurry is gravity-fed into the pressure treatment device 106, but can easily be pumped from a large, remotely located reservoir.

The dietary fibers can be provided to the reservoir 5 in any of the following states:

a) A heated mixture or slurry;

b) A mixture or slurry at ambient conditions;

c) A mixture or slurry at chilled conditions;

d) A mixture or slurry containing dispersed particles in a liquid carrier;

e) A heated solution containing dissolved fiber;

f) A solution containing dissolved fiber at ambient conditions; or

g) A chilled solution containing dissolved fiber.

All these various forms in which the fiber suspension or solution may be introduced into

the device are hereinafter collectively called the pre-mix 40 (FIG. 2).

Referring again to FIG. 2, a transfer conduit 6 leads to the pressure actuation or compression chamber 1 of the pressure treatment device 106. Transfer conduit 6 may be heated with heating coils to maintain the temperature of the pre-mix 40 as it passes to and from the pressure applicator assembly 2. At opposite ends of the pressure treatment device 106 (i.e., entry into and egress from the compression chamber 1) are placed valves 3 and 4. These valves 3 and 4 may be solenoid valves, manually operated valves or an automatic check valves. First or input valve 3 is connected to the fluid flow conduit channel 6. Second or output valve 4 is connected to an output transfer conduit 7.

Referring now to FIG. 3, the compressed air pump 2 drives a reciprocating piston 20 within housing 42, as seen in FIG. 3. Movable piston 20 is displaced within housing 42 by motor 22. Hydraulics, compressed air, electricity or combustion may power the motor 22.

The output transfer conduit 7 is connected between exit valve 4 and a baffled chamber 23. The output transfer conduit 7 has a significantly smaller inner diameter than the input transfer conduit 6. This smaller inner diameter acts to develop a backpressure within the fluid flow that helps output valve 4 to stay closed longer. This helps to maintain the elevated pressure created within the compression chamber 1 for a longer period of time. Pressure-treated materials exit the compression chamber 1, travel through the output valve 4 and transfer conduit 7 in route to the baffled chamber 23.

Bernoulli principles are employed to alter the fluid flow at the point where the flow channel diameters decrease in size. The speed of the fluid flow is increased at this point but back-pressure is built up within the fluid, which is used to keep the spring-loaded output check valve 4 closed longer than would normally be possible in a conventional hydraulic pump assembly.

Transfer conduit 7 may be heated by a heating coil (not shown) to maintain the temperature of the treated mix.

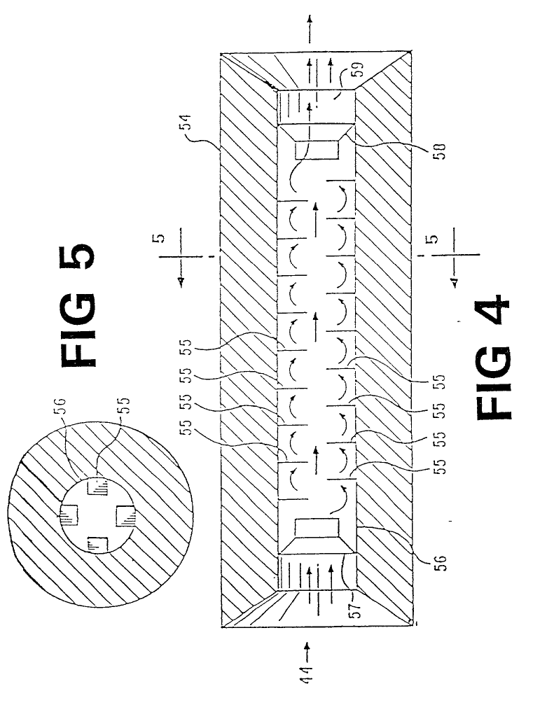

Attached to the output transfer conduit 7 is a baffled chamber 23, shown in more detail in FIG. 4. Such a chamber consists of a number of baffles 55 placed directly in the fluid flow, for the purpose of inducing turbulence in the fluid and adding to the back pressure effect within the transfer conduit 7 against the output valve 4.

In the illustrated embodiment, the pump 2 is preferably activated by compressed air. Compressed air 30 is delivered though an air conduit 8 into the air motor 22, passing through an air filter 9, a regulator 10, an air flow oil reservoir 12, a ¼ turn air valve 13, and an air inflow port 16 to the air motor 22. The air filter 9 is used to drain water from the compressed air supply 30. The regulator 10 controls the air pressure, which is displayed on the pressure gauge 11. Minute oil droplets are introduced into the compressed air supply 30 as the airflows over an oil reservoir 12. This is used to lubricate the air motor 22. The air motor cycles the piston 20 forward and backward as a result of the compressed air flow.

The number of strokes of a piston 20, as shown in FIG. 3, is controlled by the ¼ turn air valve 13. A dial is placed on the ¼ turn air valve 13 at a 90-degree incremental basis. At setting zero, the valve is fully closed and no air flows to the air motor 22. At setting nine, which is at the 90 degree mark to the horizontal, the valve is fully open and the full volume and force of the compressed air 30 is delivered to the air motor 22. At setting zero the air motor is off. At setting nine the motor 22 is at full speed. The ¼ turn air valve 13 is therefore the speed controller of the pressure-applying device 2, acting to cycle the piston 20 at its highest number of strokes.

In the case of this embodiment, the air motor 22 exhausts spent air though a muffler 15 which is connected to the outflow air port 17 of the air motor 22.

Pre-mix 40 is passed through the apparatus illustrated in FIG. 2 and is pressure-treated as the piston 20 strikes downward during its up and down displacement cycle within the pressure applicator housing 2. The valves 3 and 4 may be closed while the piston 20 is in its “downstroke” or pressure stroke, thereby trapping the pre-mix 40 in the compression chamber 1 between valves 3 and 4.

Alternatively the valve action may be adjusted to provide a semi-continuous flow, wherein check valves are used in both the inlet valve 3 and the outlet valve 4. As the piston 20 is raised, in its negative pressure cycle, a quantity of pre-mix 40 is drawn into the compression chamber 1, through inlet valve 3, while outlet valve 4 is closing up. As the piston 20 begins its pressure application or downward stroke both valves 3 and 4 may be closed for a period of time, allowing full pressure to build up within the compression chamber 1. While the pre-mix 40 is still under pressure, valve 4 opens and the pressure within the chamber 1 causes the pressure treated pre-mix 40 to flow from the compression chamber 1 out of the device through the output transfer conduit 7, into the baffled chamber 23, finally exiting the system through exit conduit 24.

FIG. 3 is a partial cut-away view of the piston pressure-applying device 2. In this embodiment, both valves 3 and 4 are spring-loaded check valves. Compressed air 30 enters the pressure treatment device 106 at the air-input port 16. Motor 22 moves the piston upwards, drawing pre-mix 40 through input valve 3 and into compression chamber 1. Input valve 3 closes as motor 22 drives the piston 20 downward through the housing 42 into the compression chamber 1. The pre-mix 40 is trapped at this point between input valve 3 and output valve 4. As the piston 20 is forced downward by the air motor 22 it strikes the surface of the pre-mix 40 and generates a shock wave through the pre-mix 40. As the motor 22 draws the piston upwards, valve 4 opens and the pressure-treated material 44 exits the machine into conduit 7, while substantially simultaneously drawing in untreated slurry through valve 3.

An apparatus that improves the cavitation effects includes a pressure treatment apparatus modified by cavitation enhancers. The cavitation enhancers are preferably ring-shaped members positioned proximate to the inlet and outlets of the pressure treatment apparatus. Tabs projecting radially inward from the perimeter of the ring disrupt the flow of the dispersion. A second type of cavitation enhancer resembles a plate having a substantially flat bottom surface and a top surface that has projections and indentations. This second type of cavitation enhancer is positioned over the strike plate of a “normal” pressure treatment apparatus in alignment with the pressure-inducing piston.

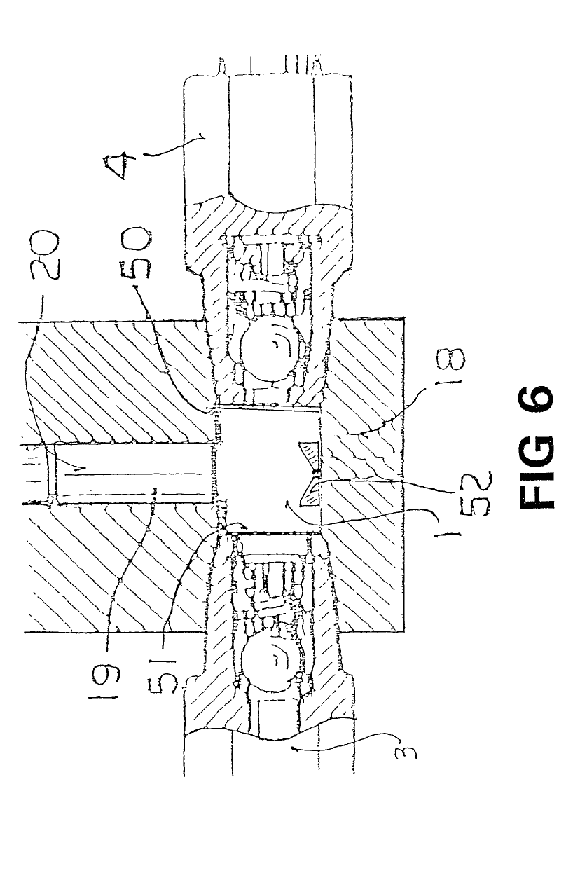

As illustrated in FIGS. 3 and 6, a series of inserts, 50, 51, and 52 act to increase the effect of cavitation within the pre-mix 40 under pressure shock treatment. These inserts increase the generation of thermal and electrostatic effects within the treated pre-mix 40 as the piston 20 begins both its positive (forward) and negative (withdrawing) application of pressure within compression chamber 1. The type of dietary fiber being treated, the carrier fluid used, and the results desired mainly determine the number of inserts and their shape. Inserts 50 and 51 are sometimes referred to as flow cavitation enhancers and insert 52 is sometimes referred to as a reflecting cavitation enhancer.

Applicants theorize that much of the altered states of the treated dietary fiber are due in part to the effect of cavitation, generated within the compression chamber 20.

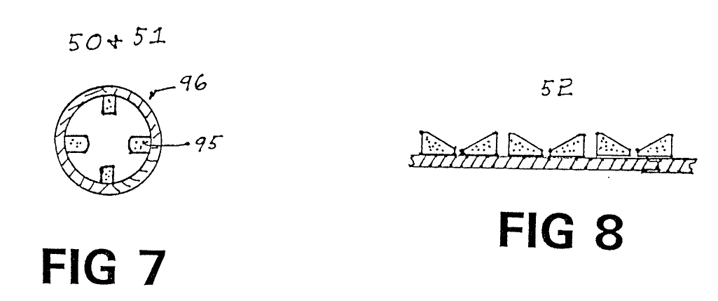

Insert 51, shown in FIG. 6 is positioned in the compression chamber 1 proximate to inlet valve 3. Referring to FIG. 7, insert 51 is comprised of one or more ring-shaped members having tabs extending radially inward. Insert 50 is positioned in the compression chamber 1 proximate to outlet valve 4. As illustrated, insert 50 is similar in shape to insert 51. Inserts 50 and 51 act to increase shear by forcing the pre-mix against a series of tabs 95 similar to that shown in the baffle of FIG. 5. As pre-mix flows through the tabs 95, inserts 50 and 51 act to generate turbulence and high shear. The number, size, shape, length and position of the tabs determine the amount of turbulence produced.

Insert 52 is illustrated in FIG. 8. In the preferred embodiment, the bottom surface of insert 52 is preferably flat. The insert 52 may be affixed to the bottom of the cavitation chamber or lie on the bottom depending on the orientation of the pressure treatment device 106. Insert 52 preferably has a regular pattern of baffles projecting upwards toward the piston. The preferred embodiment utilizes triangularly shaped baffles although other designs are also effective. The insert 52 may be of any shape as long as a plurality of baffles is placed directly under the piston 20.

The inserts 50-52 are preferably made of stainless steel, although ceramic and polymer discs have also shown to increase cavitation within chamber 1. Note that if all the inserts 52 have the same diameter as the compression chamber 1 the inserts can be easily replaced or exchanged for inserts having a different baffle or upper surface pattern.

As the piston 20 strikes the pre-mix 40 within the compression chamber 1 the pressure shock wave travels through the pre-mix 40 hitting the cavitation insert 52. There the pressure shock wave is reflected back upwards through the pre-mix. The shock wave hitting the cavitation insert 52 also generates an intense, instantaneous thermal effect which induces cavitation within the pre-mix 40, even as the piston 20 withdraws upward on its return stroke through the channel 19.

An alternative means of enhancing the cavitation effect is to utilize a vibrating plate 18 within the compression chamber 1. The vibrating plate 18 can be an ultrasonic transducer that acts to generate an ultrasonic transmission through the pre-mix 40 as the piston 20 is completing its downward stroke. The combination of an intense mechanically induced pressure shock wave against the pre-mix 40 with an ultrasonic action significantly increases the cavitation effect within the pre-mix. Although the vibrating plate 18 has a flat upper surface, it is believed that a contoured or baffled surface similar to insert 52 will have a similar effect.

A series of seals and gaskets are placed along the compression chamber to provide isolation of the pre-mix from the rest of the pressure applicator's assemblage. These are illustrated at 21 and 50 in FIG. 3.

In a conventional hydraulic pump, as the piston 20 drove downward, the output valve 4 would immediately open and allow the flow to move onward. In this case, the output valve 4 is designed to have higher tension on its check valve springs so that more pressure is required to force its opening. The result is that as the piston 20 comes downward into the compression chamber 1, both the input 3 and output 4 valves are kept in a closed position. This allows the piston 20 to generate the shock wave as it hits the pre-mix 40. If solenoid valves are used, the timing of the opening and the closing of the valves, especially the output valve 4, is adjusted to maximize the generation of the pressure shock wave generated by the piston 20 action against the pre-mix 40. The time during which the pre-mix 40 is exposed to the pressure build up within the compression chamber 1 is determined by the opening of output valve 4 and this is tied to the stroke rate determined by the ¼ turn air valve 13.

From the output channel 7, the treated material, now called the “post-mix” 44, flows into a baffled chamber 23 and finally out of the system through an exit channel 24. The baffled chamber 23 impedes the fluid flow enough for back pressure to build up against the output valve 4, keeping it closed even longer with just a step down in fluid flow channel diameters. FIG. 4 shows an embodiment of the baffled chamber 23. The housing 54 of the chamber 23 is sufficiently long to allow turbulence to build up in the post-mix 44. The length of the chamber may be varied to accommodate various treatment effects. Pressure treated fluid (post-mix) 44 enters the chamber 23 through inflow nozzle 57 which is contained within the inner diameter 56 of the hollow chamber housing 54. A series of baffles 55 are placed along the interior length of the chamber 23 to further create turbulence as the pressure treated fluid passes through the chamber. In the preferred embodiment, the baffles are actually a series of rings with projecting tabs as shown in the cross-section of FIG. 5. These tabs stick from the rings into the fluid flow, acting like baffles, and creating enhanced turbulence and shear within the pressure treated fluid 44.

While not wishing to be bound to this explanation, Applicants theorize that piston 20 acts to generate cavitation within the compression chamber 1 as the piston 20 generates its pressure shock wave effect. The shock wave acts to liberate trapped gases within the pre-mix, thereby generating heat. The heat energy so released is thought to be a major factor in the modification of the physical properties of the fiber material within the pre-mix 40. Applicants further theorize that the pressure shock wave generated within the compression chamber 1 by the action of the piston 20 has the effect of compressing the material into a tighter space. The so-compacted material would exhibit altered physical properties.

The turbulence in chamber 23 also causes a backpressure effect upon the output check valve 4 shown in FIGS. 2 and 3. This back pressure effect causes a delay in the opening of the output check valve 4 and thereby enhances the length of time that pressure is applied to the target sample.

After encountering the turbulence caused by the baffles, the pressure treated fluid 59 exits the chamber 23 through outflow nozzle 58. In FIG. 2 the inflow tubing leading to the chamber 23 is of smaller diameter than the outflow of the compression chamber 1 of the pressure applicator device 2. This step down in flow diameters helps to create the pressure shock wave effect within the compression chamber 1 by keeping output check valve 4 closed for a longer period of time. The outflow from the baffled chamber 23 is carried from the apparatus through outflow channel 24, and can then be delivered to a collection tank, or directly to a drying apparatus.

Below are reports of experiments performed on dietary fiber using the apparatus described above, in order to show the effects of proceeding in accordance with the present invention. Also included are comparisons with such fiber that has not been treated in accordance with the invention.

### Experiment 1

### Pressure Treated Fibers vs. Control Samples Water Holding Capacity After One Treatment Cycle

A slurry containing raw untreated fiber was made using from about 10 to about 17% dietary fiber in ambient tap water. The slurry was agitated for several minutes using an air stirrer until the fiber was totally dispersed. The slurry was then fed to a machine known as the Delta Processor Unit Model No. D-001 which corresponds to the apparatus shown in FIGS. 2, 3, 4 and 5 and the above technical description of that apparatus (absent cavitation enhancers described therein).

The unit was set for various inlet feed pressure settings from 60 to 90 psi. The effective pressure is multiplied 1,000 times to produce 60,000 to 90,000 psi. of compressive pressure. The slurry was treated for one treatment cycle through the machine.

The treated slurry was then filtered using a Buchner funnel attached to a vacuum pump, producing a wet cake of dietary fiber. The wet cake was then dried in an oven until the mositure level reached about 8% or less and a dried, fine, white, free flowing powder resulted. This produced the sample identified as the Pressure Treated Fiber.

Water holding capacity was measured by a procedure made available by the American Association of Cereal Chemists. The cellulose samples were analyzed using procedures prescribed by Medallion Laboratories, of Minneapolis, Minn., an independent laboratory, to determine the properties of the pressure treated fiber vs. the raw fiber.

Various fibers were treated including cellulose, wheat, wheat bran, oat and soy. Analytical tests were then conducted on various features of the control sample to the pressure treated sample, including water holding capacity, oil retention capacity, caloric content, insoluble fiber content, fat content and other features. The tables listed below detail the analytical results and show the changes effected in the pressure treated fibers.

### List of Tables

Table 1 presents the results found for water holding capacity, after one treatment cycle.

Table 1a presents the impact of heated mixing on a variety of fiber materials absent pressure treatment.

Table 2 illustrates the analytical results found for water holding capacity using multiple treatment cycles.

Table 3 illustrates the analytical results found for water holding capacity, after one treatment cycle, wherein ethanol was used instead of water as the solvent or liquid media.

Table 4 compares raw cellulose fiber to pressure treated cellulose fiber in terms of dietary analytical results.

Table 5 illustrates the analytical results found for oil retention and holding capacity, after one treatment cycle.

Table 6 presents the results of moisture level and water-holding capacity of fibers subjected to different pressures and drying techniques.

Table 7 is a listing of the many food products that can be utilized by this invention, either already classified as a dietary fiber or which can be so classified after pressurization treatment.

TABLE 1
COMPARISON OF RAW FIBERS
AND PRESSURE TREATED FIBERS
WATER HOLDING CAPACITY

| | WATER HOLDING | CHANGE IN WATER |
|---|---|---|
| FIBER TYPE | CAPACITY | HOLDING CAPACITY |
| BH 200 | 360% | 0% |
| BH 200/90K | 326% | −34% |
| WHEAT BRAN (100 | 280% | 0% |
| mesh) | | |
| DELTA WHEAT | 394% | +41% |
| BRAN (100 mesh)/90K | | |

BH 200=Powdered Cellulose supplied by International Filler Corp, Untreated control sample

BH 200/90K=Powdered Cellulose supplied by International Filler Corp, treated at 90,000 Psi.

WHEAT BRAN=Wheat bran flake supplied by ADM Corp. and micronized, Untreated control sample.

DELTA WHEAT BRAN/90K=Wheat bran flake supplied by ADM Corp. and micronized, treated at 90,000 Psi.

All studies used just one treatment cycle through the apparatus. The treated fibers were all in a slurry form, using water as the liquid carrier, under ambient temperature conditions.

From this data it can be clearly seen that the pressure treatment caused a significant reduction in water holding capacity in cellulose BH-200, while the water holding capacity for treated wheat bran exhibited an increase.

An experiment was designed to determine if the water-holding capacities of the dietary fibers could be modified by elevated temperature alone. Consequently, a Hobart mixer was used to mix the slurries of aqueous fiber at a temperature between about 65 and 100 degrees C. until the moisture level reached below about 10%. The results are present in Table 1A below.

TABLE 1A

| | | |
|---|---|---|
| Dietary Fiber | Water-Holding Capacity | Percent change |

| | | |
|---|---|---|
| OAT OPTA | 586% | 0% |
| OAT | 371% | −37% |
| Hobart mixed and dried | | |
| SOY | 273% | 0% |
| SOY | 209% | −23% |
| Hobart mixed and dried | | |
| WHEAT 3000 | 421% | 0% |
| WHEAT 3000 | 193% | −54% |
| Hobart mixed and dried | | |
| OAT HULL C.H. | 318% | 0% |
| OAT HULL C.H. | 240% | −25% |
| Hobart mixed and dried | | |

OAT OPTA=Oat fiber supplied by OPTA Food Ingredients Corp., Untreated control sample

SOY=Soy fiber supplied by Fibred Corp., Untreated control sample

WHEAT 1000=Wheat fiber supplied by Watson foods Corp., model no 1,000, Untreated control sample.

WHEAT 3000=Wheat fiber supplied by Watson foods Corp., model no 3,000, Untreated control sample.

OAT HULL C.H.=Fiber derived from oat hulls, supplied by Canadian Harvest Corp. and known as no. Sno-White, Untreated control sample.

The reductions in water-holding capacity caused by the heated mixing procedure suggest that the properties of fiber ingredients used in applications where elevated temperatures are used change during processing. The use of the pressure-treated fiber according to the present invention provides a means to reduce undesirable property changes of fiber ingredients during subsequent processing.

### Experiment #

### Multiple Pressure Treatment Cycles

The procedure described in experiment #1 is repeated for various cellulose fibers, but instead of one treatment cycle the material is treated for a total of five passes through the apparatus. The results are indicated in Table 2, wherein it can be seen that in most cases the benefits of multiple pressure treatment cycles tends to obtain a lower water holding capacity than can be achieved with just a single cycle. These tests were conducted using different cellulose sources, soft and hard woods and cellulose derived from plants, i.e. cottonseed cellulose.

TABLE 2
COMPARISON OF WATER HOLDING CAPACITY:
PRESSURE TREATED FIBERS
SUBJECTED TO MULTIPLE TREATMENT
PASSES WITH RAW FIBERS

| | WATER HOLDING | CHANGE IN WATER |
|---|---|---|
| FIBER TYPE | CAPACITY | HOLDING CAPACITY |
| BH 200 | 360%* | 0% |
| BH 200/901 | 225% | −38% |
| BH 200/905 | 241% | −33% |
| B-600 | 362% | 0% |
| B-600/901 | 319% | −12% |
| B-600/905 | 289% | −20% |
| HKB-300 | 384% | 0% |
| HKB-300/901 | 282% | −27% |
| HKB-300/905 | 315% | −18% |

*Different technicians obtained WHC values ranging from 295-391%.
BH 200 = Cellulose fiber derived from softwoods, supplied by International Filler Corp.
BH 200/901 = Cellulose fiber derived from soft woods, supplied by International Filler Corp., treated at 90,000 psi at one treatment cycle.
BH 200/905 = Cellulose fiber derived from soft woods, supplied by International Filler Corp., treated at 90,000 psi at five treatment cycles.
B-600 = Cellulose fiber derived from Hardwoods, supplied by International Filler Corp.
B-600/901 = Cellulose fiber derived from Hard woods, supplied by International Filler Corp., treated at 90,000 psi at one treatment cycle.
B-600/905 = Cellulose fiber derived from Hard woods, supplied by International Filler Corp., treated at 90,000 psi at five treatment cycles.
HKB-300 = Cellulose fiber derived from cottonseed pulp, supplied by International Filler Corp.
HKB-300/901 = Cellulose fiber derived from cottonseed pulp, supplied by International Filler Corp., treated at 90,000 psi at one treatment cycle.
HKB-300/905 = Cellulose fiber derived from cottonseed pulp, supplied by International Filler Corp., treated at 90,000 psi at five treatment cycles.

Except for BH-600 where water-holding capacity was decreased further upon multiple pressure treatments, it appears that a single pass at 90 k psi achieves a maximum reduction in water holding capacity for cellulose fibers.

### Experiment #3

### Use of a Solvent During Pressure Processing

The procedure of Experiment 1 is followed using cellulose fiber, but ethanol is replaced as the liquid carrier or solvent. The test was to demonstrate that the pressure treatment effect is also manifested in an organic solvent. Table 3 shows ethanol processing of BH-200 and BH-300, both cellulose fibers supplied by International Filler Corp. (BH-300 comprises smaller particles).

TABLE 3
WATER HOLDING CAPACITY
ETHANOL PROCESSING

| | ORIGINAL | WATER HOLDING | CHANGE IN |
|---|---|---|---|
| | WATER | CAPACITY AFTER | WATER |
| | HOLDING | PRESSURE | HOLDING |
| CELLULOSE | CAPACITY | TREATMENT* | CAPACITY |
| FIBERS | ambient | ambient | ambient |
| BH-200 | 338% | 312% | −7.69% |
| BH-300 | 358%** | 324%*** | −9.5% |

*Pressure setting at 90,000, for one treatment cycle.
**Average of three values.
***Values obtained ranging from 303 to 329%.

In both instances pressure applications used in conjunction with an organic solvent also resulted in altered physical properties for the treated fiber.

### Experiment #4

### Full Dietary Analysis of Raw Cellulose vs. Pressure Treated Cellulose Treated at 90,000 PSI

The procedure of Experiment #1 is conducted using water as the carrier and BH-200 cellulose fiber supplied by International Filler Corp. The fiber was subjected to 90,000 psi for one treatment cycle. A comparison of dietary features was conducted on the raw untreated original material vs. the pressure treated cellulose. The results are listed in Table 4.

TABLE 4
COMPARISON OF PRESSURE TREATED CELLULOSE
FIBER WITH RAW CELLULOSE FIBER

| | | PRESSURE |
|---|---|---|
| FEATURE | RAW FIBER | TREATED FIBER |
| PARTICLE SIZE (microns) | 50 | 50 |
| FAT, ACID HYDROLYSIS | 0% | 0.2% |
| INSOLUBLE FIBER | 89.72% | 95.08% |
| SOLUBLE FIBER | 0% | 0% |
| TOTAL DIETARY FIBER | 89.72% | 95.08% |
| PROTEIN | 0.05% | 0.07% |
| MOISTURE | 5.21% | 5.72% |
| ASH | 0.176% | 0.229% |
| CALORIES/100 GRAMS | 20.0 | 2.0 |
| CALORIES FROM FAT | 2.0 | 0.02 |
| CARBOHYDRATES AVAIL. | 4.8% | 0% |
| CARBOHYDRATES, TOTAL | 94.6% | 93.8% |
| DENSITY | 1.611 g/cm³ | 1.56 g/cm³ |

Tests conducted by Medallion Laboratories, Minneapolis, Minn.

The pressure treated sample is low in calorie content, (only 2 calories/100 grams) and high in insoluble fiber content (95.08%).

A key feature of the pressure treated dietary fiber is its low calorie content for cellulose fiber: 2.0 calories vs. 20 calories per gram for the raw untreated cellulose fiber. This effect of the pressure processing is also reflected in the Carbohydrates Available number, which was 4.8% for the raw untreated cellulose fiber and 0% for the pressure treated sample. This is an indicator that the fat content of the fiber has been reduced via the pressure processing treatment. The insoluble fiber content has increased in the pressure treated dietary fiber from 89.72% to 95.08%.

These property differences may be due to the following modifications of the fiber caused by the pressure treatment processing.

1) An increase in the insoluble (i.e. indigestible) fiber component of the fiber, essentially making more of the material indigestible, and thereby reducing absorbed calories. In the instance of the cellulose fiber, the insoluble fiber was originally 89.72%, but after pressure treatment the insoluble fiber component was raised to 95.5%, a 6 percent increase in indigestible fiber content.

2) As further evidence of the effects of digestible component reorganization, the “carbohydrates available” test revealed a reduction in carbohydrates from 4.8% in the raw sample to 0.0% for the pressure treated sample.

3) The reduction in carbohydrates also exhibits lower calories derived from fat content from 2.0 calories/gram to 0.02 calories/gram in the instance of the cellulose fiber. This suggests that the fat component of the material may be separated and removed from the pressure treated material during processing.

### Experiment #5

### Test for Oil Absorption and Retention Properties

Samples are analyzed for oil absorption and retention properties. A fiber or flour will tend to absorb vegetable oil during a frying process, and along with it absorb fat and calories. The use of pressure treatments applied to dietary fibers and to flour will tend to reduce the absorption and retention ability for oil, resulting in fried batters and fried breading which exhibit reduced overall fat content and lower overall calories. A typical example of a fried batter would be a pancake mix. Examples of a fried breaded coating would be breaded chicken, shrimp, fish, or certain fried or extruded snack foods. In the fibers listed in Table 5 the pressure setting for the pressure treated versions was 90,000 psi.

TABLE 5
OIL RETENTION CAPACITY OF
PRESSURE TREATED FIBERS

| | OIL RETENTION | CHANGE IN OIL |
|---|---|---|
| FIBER TYPE | CAPACITY | RETENTION CAPACITY |
| BH 200 | 223% | 0% |
| BH 200/90k | 138% | −38% |
| SOY | 139% | 0% |
| SOY/90K | 209% | +23 |
| WHEAT 1000 | 440% | 0% |
| WHEAT 1000/90K | 135% | −69% |
| WHEAT FLOUR | 95% | 0% |
| WHEAT FLOUR/90K | 89% | −6% |
| WHEAT BRAN | 116% | 0% |
| WHEAT BRAN/90K | 165% | +42% |

BH 200 = Powdered Cellulose supplied by International Filler Corp, Untreated control.
BH 200/90K = Powdered Cellulose supplied by International Filler Corp. treated at 90k psi.
SOY = Soy fiber supplied by Fibred Corp., untreated control.
SOY/90K = Soy fiber supplied by Fibred Corp., treated at 90k psi.
WHEAT 1000 = Wheat fiber supplied by Watson Foods Corp. untreated control.
WHEAT 1000/90K = Wheat fiber supplied by Watson foods Corp. treated at 90k psi.
WHEAT Flour = Wheat flour supplied by the Snavely Mill Co., untreated control.
WHEAT FLOUR/90K = Supplied by Snavely Mill Co., treated at 90k psi.
WHEAT BRAN = micronized (100 mesh) wheat bran flake (ADM Corp.) Untreated control.
WHEAT BRAN/90K = micronized (100 mesh) wheat bran flake (ADM Corp). treated at 90k psi.

In most instances the use of pressure treatment effects a lowering of the oil absorption and retention properties in the resultant fiber, however it is possible to effect an increase in oil retention in certain fibers as well.

### Experiment #6

### Effects of Various Pressure Levels and Drying Methods on Dietary Fiber Products

Many different methods of removing the water solvent medium introduced in the present method are available. Other than freeze-drying, which is not believed to be a commercially viable method for the preparation of the modified dietary fibers described herein, drying techniques such as fluid-bed, and oven drying are available. Both the fluid-bed and oven require elevated temperatures that drive the residual water from any filtered fiber product. As described in Table 1A, some of the fiber materials experienced significant reductions in water holding capacity simply upon heating and mixing in a Hobart mixer. Since such changes are likely to be encountered in food processing applications, applicants arranged for the design and implementation of an experimental program directed to isolate different factors that may impact water holding capacity and properties during food processing applications. These factors included temperature, moisture absorption, removal of water-soluble components and physical processing which would reduce the product particle size content.

Table 7 shows the results of this experimental program. The dietary fiber materials tested were cellulose fiber (BH-200), Opta Oat 741, Soy fiber (Fibred), White Wheat 1000, Wheat 3000, Wheat Bran (100 mesh) and Oat Hull (SNOWITE 300), of which each source is described hereinabove.

Each material was purchased from the supplier immediately prior to testing. The procedure for the test work was as follows:

1) For each material tested, a raw sample, a control sample and multiple test samples were prepared. Three measurements of water-holding capacity were made from each processed, control and raw sample to secure a median value and standard deviation. Moisture content of each sample was measured prior to determining the water-holding capacity.

2) 100 g of sample material is dispersed into a 2000 ml beaker containing 900 ml distilled water. The mixture is stirred for 30 seconds.

3) For recovered control, skip step 4.

4) Pressure treat the suspension at the selected pressure for one or five passes through the Delta machine.

5) Separate 350 ml of the pressure treated or control material for settling into an 800 ml beaker.

6) Filter the 650 ml of remaining material using a #4 vacuum filter ensuring that the cake is uniformly under vacuum.

7) Granulate the filter-dried material using a tabletop Hobart mixer for 1-2 min.

8) Place half of the material by weight from step 7 into an aluminum pan, and then into an oven set to 70° C.

9) Maintain the material in the oven at 70° C. until the moisture level is at or below about 5%.

10) The other half of the material from step 8 above is introduced into a fluidized bed machine under the following conditions: Aspirator=0.2−0.24 m³/min, inlet temperature=110° C. The material is initially pulse stirred for 1 second with a three second until the material can fluidize by itself, after which the sample is fluidized for an additional 10-15 min until the moisture level is at or below 5%.

11) Decant material of step 5 one hour later; subject precipitated material to steps 6, 7, 8 and 9.

TABLE 6
WATER-HOLDING CAPACITY OF FIBERS
SUBJECTED TO DIFFERENT PRESSURES AND DRYING TECHNIQUES

| | | | | | % Water | | % Water | |
|---|---|---|---|---|---|---|---|---|
| | | | % Water | | Absorption | | Absorption | |
| | % Water | % | Absorption | % | *Settle/Filter/ | % | Filter/Fluid | % |
| Sample | Absorption | Moist. | Filter/Oven | Moist. | Oven | Moist. | Bed | Moist. |
| BH-200 | 396.9 | 5.2 | | | | | | |
| cellulose fiber | (+ −) | | | | | | | |
| Sample 1 | 6.6 | | | | | | | |
| Sample 2 | | | 338.6 | 3.5 | 331.8 | 2.6 | 326.3 | 5 |
| Ok -control | | | (+ −) | | (+ −) | | (+ −) | |
| | | | 4.0 | | 4.2 | | 13.4 | |
| Sample 3 | | | 317.3 | 4.7 | 337 | 5.1 | 342.6 | 4.5 |
| 13k(0.1 sec) | | | (+ −) | | (+ −) | | (+ −) | |
| | | | 5.2 | | 9.2 | | 7.1 | |
| Sample 4 | | | 351.2 | 3.9 | 374 | 2.3 | 352.6 | 3.6 |
| 40k(0.1 sec) | | | (+ −) | | (+ −) | | (+ −) | |
| | | | 2.5 | | 6.5 | | 3.2 | |
| Sample 5 | | | 359.5 | 4.8 | 354 | 4.3 | 342.1 | 4.2 |
| 60k(0.1 sec) | | | (+ −) | | (+ −) | | (+ −) | |
| | | | 11.0 | | 0.6 | | 3.2 | |
| Sample 6 | | | 374.3 | 3.1 | 372.9 | 5 | 347.4 | 3.3 |
| 90k(0.1 sec) | | | (+ −) | | (+ −) | | (+ −) | |
| | | | 5.3 | | 6.9 | | 1.6 | |
| Sample 7 | | | 352.0 | 2.5 | 367 | 2.7 | 361.8 | 4.9 |
| 13k(0.1 sec); | | | (+ −) | | (+ −) | | (+ −) | |
| 5x | | | 1.9 | | 9.1 | | 1.3 | |
| Opta Oat 741 | 462.8 | 5.6 | | | | | | |
| Sample 8 | (+ −) | | | | | | | |
| | 5.4 | | | | | | | |
| Sample 9 | | | 546.2 | 4.3 | 555 | 3.8 | 505.4 | 3.4 |
| Ok -control | | | (+ −) | | (+ −) | | (+ −) | |
| | | | 2.4 | | 4.3 | | 1.4 | |
| Sample 10 | | | 498.9 | 4.1 | 550.5 | 3.6 | 507.5 | 4.2 |
| 13k(0.1 sec) | | | (+ −) | | (+ −) | | (+ −) | |
| | | | 3.9 | | 2.4 | | 7.6 | |
| Sample 11 | | | 557.4 | 4.5 | 558.7 | 3.9 | 512.9 | 2.1 |
| 90k(0.1 sec) | | | (+ −) | | (+ −) | | (+ −) | |
| | | | 1.5 | | 2.2 | | 3.3 | |
| Soy (Fibred) | 296.6 | 5 | | | | | | |
| Sample 12 | (+ −) | | | | | | | |
| | 1.6 | | | | | | | |
| Sample 13 | | | 291.0 | 3.4 | 290.2 | 2.6 | 282.5 | 3.2 |
| Ok -control | | | (+ −) | | (+ −) | | (+ −) | |
| | | | 4.5 | | 1.3 | | 1.0 | |
| Sample 14 | | | 295.1 | 4.4 | 301 | 4.4 | 280.3 | 3.1 |
| 13k(0.1 sec) | | | (+ −) | | (+ −) | | (+ −) | |
| | | | 5.8 | | 3.4 | | 2.5 | |
| Sample 15 | | | 325.0 | 3.4 | 323 | 2.1 | 316.2 | 3 |
| 90k(0.1 sec) | | | (+ −) | | (+ −) | | (+ −) | |
| | | | 6.4 | | 3.8 | | 2.6 | |
| White Wheat | 507.4 | 7.1 | | | | | | |
| Sample 16 | (+ −) | | | | | | | |
| (1000) | 5.8 | | | | | | | |
| Sample 17 | | | 462.6 | 2.9 | 486 | 5.3 | 455.7 | 5.1 |
| Ok -control | | | (+ −) | | (+ −) | | (+ −) | |
| | | | 1.9 | | 1.4 | | 1.0 | |
| Sample 18 | | | 473.9 | 3.7 | 452 | 5.3 | 464.6 | 4.3 |
| 13k(0.1 sec) | | | (+ −) | | (+ −) | | (+ −) | |
| | | | 1.0 | | 3.0 | | 2.9 | |
| Sample 19 | | | 471.2 | 4 | 451 | 4.1 | 505.9 | 2.8 |
| 90k(0.1 sec) | | | (+ −) | | (+ −) | | (+ −) | |
| | | | 2.8 | | 3.9 | | 5.5 | |
| Wheat 3000 | 493.9 | 8.6 | | | | | | |
| Sample 20 | (+ −) | | | | | | | |
| | 3.1 | | | | | | | |
| Sample 21 | | | 479.9 | 5.1 | 450 | 3.1 | 468.1 | 4.3 |
| Ok -control | | | (+ −) | | (+ −) | | (+ −) | |
| | | | 3.6 | | 2.7 | | 3.6 | |
| Sample 22 | | | 461.7 | 3.6 | 462 | 5.1 | 447.7 | 3 |
| 13k(0.1 sec) | | | (+ −) | | (+ −) | | (+ −) | |
| | | | 2.1 | | 2.0 | | 11.4 | |
| Sample 23 | | | 460.2 | 0 | 449 | 3.4 | 435.3 | 4.7 |
| 90k(0.1 sec) | | | (+ −) | | (+ −) | | (+ −) | |
| | | | 3.1 | | 7.1 | | 12.1 | |
| Wheat Bran | 191.1 | 6.9 | | | | | | |
| (−100 mesh) | (+ −) | | | | | | | |
| Sample 24 | 1.2 | | | | | | | |
| Sample 25 | | | 264.1 | 2.3 | 297.1 | 2.4 | 289.8 | 0.8 |
| Ok -control | | | (+ −) | | (+ −) | | (+ −) | |
| | | | 7.7 | | 8.8 | | 8.5 | |
| Sample 26 | | | not feasible | | | | | |
| 13k 0.1 sec | | | | | | | | |
| Sample 27 | | | 276.6 | 3.8 | 299.9 | 2.8 | 294.7 | 1.2 |
| 90k(0.1 sec) | | | (+ −) | | (+ −) | | (+ −) | |
| | | | 5.9 | | 12.2 | | 0.6 | |
| Oat Hull | 398.7 | 6.4 | | | | | | |
| Sample 28 | (+ −) | | | | | | | |
| (SNOWITE 300) | 3.7 | | | | | | | |
| Sample 29 | | | 449.8 | 4.8 | 471 | 4.1 | 420.0 | 1.4 |
| Ok -control | | | (+ −) | | (+ −) | | (+ −) | |
| | | | 3.6 | | 1.5 | | 9.1 | |
| Sample 30 | | | 473.7 | 3.6 | 443.6 | 5.1 | 427.9 | 2.6 |
| 13k | | | (+ −) | | (+ −) | | (+ −) | |
| | | | 15.2 | | 1.1 | | 4.2 | |
| Sample 31 | | | 492.4 | 4.4 | 509.8 | 4.8 | 421.8 | 4.5 |
| 90k(0.1 sec) | | | (+ −) | | (+ −) | | (+ −) | |
| | | | 0.6 | | 4.6 | | 3.0 | |

The data presented in Table 6 shows the clear impact of an elevated temperature work-up procedure on the water-holding capacity (WHC) properties of some of the dietary fiber materials tested. In addition to the temperature impact, the physical processing introduced by the fluidized bed device resulted in the production of finer powders and most likely caused a reduction in particle size content by breaking up particle agglomerates produced by pressure and/or temperature processing. In addition, the filtering procedure is expected to remove a substantial portion of water soluble components, while the decanting procedure is expected to remove the smallest particles remaining in suspension as well as any lighter than water immiscible materials that may separate from the fiber material during pressure treatment.

Table 7 data demonstrates that the pressure process modifies the WHC properties. In some cases, pressure treated fiber material such as cellulose BH-200 experiences a reduction in WHC relative to the raw unprocessed material but an increase in WHC relative to the control material. In other cases, the pressure treated material such as Soy and Oat hull experiences a significant increase in WHC relative to both raw and control materials. For Oat hull, WHC values are the highest for materials not subjected to the fluid bed treatment; consequently, the increase appears to be attributable to retention of larger pressure induced particles that appear to be disrupted by the mechanical action of the fluid bed and to the removal by decanting of the smallest particles.

In some cases, such as Opta oat and wheat bran (100 mesh), a significant increase in WHC appears to be the result of filtering and heat factors since the WHC for pressure treated samples are essentially the same as for the control regardless of the workup procedure.

In still other cases, such as Wheat 3000, the WHC properties of the controls are only slightly lowered, with the lowest value attributable to the decanting procedure. However, the pressure treated Wheat 3000 experienced the greatest reduction in WHC when subjected to the action of the fluid bed. This data supports the conclusion that the 90,000 psi treatment coupled with the fluid bed workup is able to process Wheat 3000 in a manner which produces a wheat fiber product possessing substantially lower WHC properties.

The higher the pressure used in the experiment, the greater the likelihood that a modification in WHC is obtained. However, in some experiments, subjecting the material to one or five passes at the lower 13,000 psi setting resulted in comparable WHC values. Each material appears to react to the pressure treatment differently.

The difference between the 13,000 psi and 90,000 psi treatment is most easily seen in the Soy data where the 13,000 psi treated samples differed little from the control samples, while the 90,000 k samples experienced a 33% increase in WHC relative to the control samples.

Another difference is seen in the White Wheat 1000 data. While it appears that the elevated temperature caused a reduction in WHC for the control and all treated samples to about the same degree, the 90,000 psi treated sample subjected to the fluid bed recovered WHC to the level of the raw unprocessed material. This data supports the conclusion that the 90,000 psi treatment coupled with the fluid bed workup is able to process wheat fiber having the particle size distribution of White Wheat 1000 in a manner which produces a wheat fiber product more likely to be stable and retain its WHC during elevated temperature food processing.

In addition to the drying temperature and physical manipulation used in the sample workup, additional experiments have shown that the temperature at which the pressure treatment is performed, the specific dietary fiber composition starting material, and the concentration of sample in the suspension during pressure treatment are factors which influence both the direction and absolute value of the change in water holding capacity properties. Consequently, these variables must be controlled to obtain consistent and reproducible results.

While but a few examples of dietary fibers have been discussed in this invention it should be obvious that there are several food stuffs or grains which are now classified as dietary fibers or which may be so classified after pressure treatment, including but not limited to the list provided in Table 7.

TABLE 7
PARTIAL LISTING OF VARIOUS DIETARY FIBER
PRODUCTS SUITABLE FOR ENHANCEMENT VIA
PRESSURE PROCESSING TECHNIQUES IN
ACCORDANCE WITH THE PRESENT INVENTION

| | |
|---|---|
| APPLE FIBER | SODIUM CARBOXYMETHYL |
| BRAN FIBER | CELLULOSE |
| BARLEY BRAN FLOUR | CORN FLOUR |
| FLOUR | CORN HUSKS |
| FIG POWDER | DRIED CRANBERRIES |
| BARLEY FLOUR, HIGH | DE-FATTED WHEAT GERM |
| PROTEIN | FIBERS DERIVED FROM OAT HUSKS |
| BARLEY FIBER | PEANUT FLOUR |
| BREWER'S SPENT GRAINS | MICROCRYSTALLINE CELLULOSE |
| BARLEY'S BEST HIGH | TARA GUM |
| PROTEIN FLOUR | LOCUST BEAN GUM |
| BARLEY RICE | OAT BRAN |
| CORNSTARCH MALTED | OAT FIBER |
| GERM | PEA FIBER |
| BLEACHED CORN FIBER | POWDERED CELLULOSE |
| CARRAGEEN GUM | PECTIN |
| CELLULOSE GUM | PRUNES, DRIED |
| CITRUS FIBER | RICE BRAN, DE-FATTED |
| COCOA | |
| CORN BRAN | |
| CORN FIBER | |
| RICE BRAN, STABILIZED | |
| RICE FIBER | |
| CELLULOSE FIBERS | |
| SOY FIBER | |
| SUGAR BEET FIBER | |
| WHEAT BRAN | |
| WHEAT FIBER | |
| WHEAT FLOUR | |
| WHEAT GERM, | |
| DE-FATTED | |
| XANTHAN GUM | |

COMBINATIONS OF ANY NUMBER OF THE ABOVE FIBERS
BLENDS OF ABOVE FIBERS IN A RAW STATE WITH THEIR PRESSURE TREATED VERSIONS
ANY OTHER SUBSTANCE USED AS A DIETARY FIBER

COMBINATIONS OF ANY NUMBER OF THE ABOVE FIBERS

BLENDS OF ABOVE FIBERS IN A RAW STATE WITH THEIR PRESSURE TREATED VERSIONS

ANY OTHER SUBSTANCE USED AS A DIETARY FIBER

### Experiment 8

### Using Pressure Treated Fiber (Cellulose) in Various Baked Food Formulations

Cellulose fiber, BH-200, which is pressure treated according to the parameters set forth in Experiment #1, is used in various baked food recipes. It was discovered that the pressure treated fiber could replace more of the flour used in the recipe as opposed to the raw untreated fiber. The Flour Replacement value is a based upon the machining stress or torque generated by a Hobart planetary mixer in a standard recipe. Since the raw fiber tended to absorb a great deal of water it required more water and thereby placed more strain on the mixing machinery. This also required more time to bake to remove the absorbed moisture. Since the pressure treated version enjoyed a lower water holding capacity the torque was less, and the bake out time was less. By replacing more flour with a dietary fiber a corresponding lowering of the calories in the final baked product resulted.

Recipes 1 through 5 illustrate the features and procedures for making an improved dietary product incorporating pressure treated fiber.

RECIPE 1
PRESSURE TREATED CELLULOSE IN
APPLE MUFFINS

| | CALORIES/SERVING |
|---|---|
| ORIGINAL RECIPE | 190 |
| PRESSURE TREATED VERSION | 155 |

INGREDIENTS AND MEASUREMENTS

| | ORIGINAL | | REVISED |
|---|---|---|---|
| INGREDIENT | RECIPE | | RECIPE |
| Milk | 250 | ml | same |
| Vegetable oil | 35 | ml | same |
| Vanilla | 2.5 | ml | same |
| Eggs | 1 | | same |
| All-purpose flour | 204 | g | 152 g |
| PRESSURE TREATED CELLULOSE/901 | 0 | g | 52 |
| Sugar | 60 | g | 60 g |
| Baking powder | 11 | g | same |
| Salt | 3 | g | same |
| Grated apples | 1 | cup | same |
| Ground cinnamon | 4 | g | same |
| STREUSEL TOPPING: | | | |
| All-purpose flour | 30 | g | same |
| Packed brown sugar | 36 | g | same |
| Margarine or butter | 25 | g | same |
| Ground cinnamon | 3 | g | same |

SERVES: 12
Preparation Time: 30 Minutes
Elapsed Time: 1 Hour
Bake Time: 20 to 25 Minutes
Oven Temp: 400° (F.)
* If using self-rising flour, omit baking powder and salt.

### Baking Instructions

Heat oven to 400 degrees. Prepare Streusel Topping. Grease bottoms only of 12 medium muffin cups, 2-½×1-¼ inches, or line with paper baking cups. Beat milk, oil vanilla and egg. Stir in flour, sugar, baking powder, salt and cinnamon all at once until flour is moistened (batter will be lumpy). Fold in apples. Divide batter evenly among muffin cups. Sprinkle each with about 2 teaspoons Streusel Topping. Bake 20 to 25 minutes or until golden brown. Immediately remove from pan.

Streusel Topping:

Mix all ingredients until crumbly.

Copyright 1996 Delta Food Group

Darby, Pa.

RECIPE 2
PRESSURE TREATED CELLULOSE IN
BROWNIES

| | CALORIES/SERVING |
|---|---|
| ORIGINAL RECIPE | 37 |
| PRESSURE TREATED VERSION | 21 |

INGREDIENTS AND MEASUREMENTS

| INGREDIENTS | ACTUAL % | BAKERS % |
|---|---|---|
| PRESSURE TREATED CELLULOSE/901 | 5.19% | 25% |
| All-purpose flour | 15.59% | 75% |
| Baker's sugar | 27.70% | 133.3% |
| Powdered sugar | 14.07% | 67.7% |
| Baking Soda | 0.08% | 0.4% |
| Salt | 0.54% | 2.6% |
| Shortening (vegetable) | 2.95% | 14.2% |
| Dry egg white | 0.37% | 1.8% |
| Mono calcium phosphate | 0.04% | 0.2% |
| Whole eggs | 6.59% | 31.7% |
| water (60 f) | 9.87% | 47.5% |
| Vanilla flavor | 0.15% | 0.7% |
| Soybean oil | 11.34% | 54.6% |
| Dutch Cocoa | 5.15% | 24.8% |
| Mono & Diglycerides | 0.37% | 1.8% |
| TOTAL | 100% | 481.3% |

SERVES: 72
Preparation Time: 15 Minutes
Elapsed Time: 45 Minutes
Bake Time: 23 Minutes/convection
Oven Time: 350° (F.)

### Baking Instructions

Heat Oven to temperature. Cream Mono & Diglycerides and bakers sugar together on medium speed. Dry Blend with other ingredients at low speed for 5 minutes. Add water. Mix 2 minutes. Scrape down after 1 minute. Bake in convection oven for 23 minutes at 350 (f).

Copyright 1996 Delta Food Group

Aston, Pa.

RECIPE 3
PRESSURE TREATED CELLULOSE IN
WHOLE WHEAT BATTER BREAD

| | CALORIES/SERVING |
|---|---|
| ORIGINAL RECIPE | 85 |
| PRESSURE TREATED VERSION | 67 |

INGREDIENTS AND MEASUREMENTS

| | ORIGINAL | | REVISED | |
|---|---|---|---|---|
| INGREDIENT | RECIPE | | RECIPE | |
| PRESSURE TREATED | 0 | g | 96 | g |
| CELLULOSE/901 | | | | |
| All-purpose flour | 3-½ | cups | 384 | ml |
| Sugar | 2 | tsp. | 9 | |
| Baking powder | ¼ | tsp. | 1.3 | |
| Dry yeast (regular/quick-acting) | 1 | tsp. | 5 | |
| Milk (very warm 120-130°) | ½ | cup | 125 | ml |
| Water (very warm 120-130°) | 2 | cups | 500 | ml |
| Whole wheat flour | 2 | cups | 260 | ml |
| Raisins | 1 | cup | same | |
| All-purpose flour | 1-1 ¼ | cups | 130-150 | ml |
| Cornmeal | ½ | cup | 125 | ml |

SERVES: 2 Loaves/16 slices ea.
Preparation Time: 15 minutes
Elapsed Time: 1 Hour 15 Minutes
Bake Time: 25 Minutes
Oven Temp: 400° (F.)
* If using self-rising flour, omit baking powder and sale

### Baking Instructions

Mix 3-½ cups all-purpose flour, the sugar, salt, baking soda and yeast in large bowl. Add warm milk and warm water. Beat on low speed until moistened. Beat 3 minutes on medium speed, scraping bowl occasionally. Stir in whole wheat flour, raisins and enough remaining all-purpose flour to make a stiff batter.

Grease 2 loaf pans, 8-12×4-½×2-½ inches and sprinkle with cornmeal. Divide batter evenly between pans. Round tops of loaves by patting with floured hands. Sprinkle with cornmeal. Cover and let rise in warm place about 30 minutes or until batter is about 1 inch below top of pan.

Heat oven to 400 degrees. Bake about 25 minutes or until loaves are light brown; remove from pans. Cool on wire rack.

RECIPE 4
PRESSURE TREATED CELLULOSE IN
CHOCOLATE CHIP COOKIES

| | CALORIES/SERVING |
|---|---|
| ORIGINAL RECIPE | 90 |
| PRESSURE TREATED VERSION | 67.5 |

INGREDIENTS AND MEASUREMENTS

| | ORIGINAL | REVISED |
|---|---|---|
| INGREDIENT | RECIPE | RECIPE |
| PRESSURE TREATED CELLULOSE/901 | 0 g | 70 g |
| All-purpose flour | 210 g | 140 g |
| Packed brown sugar | 170 g | 150 g |
| Granulated sugar | 217 g | 200 g |
| Baking soda | 5 g | same |
| Salt | 3 g | same |
| Shortening (margarine) | 190 g | same |
| Coarsely chopped nuts | 1 cup | same |
| Semi-sweet chocolate chips | variable | same |
| Eggs | 1 | same |

SERVES: 72 Cookies
Preparation Time: 15 Minutes
Elapsed Time: 45 Minutes
Bake Time: 8-10 Minutes
Oven Temp: 375° (F.)
* If using self-rising flour, omit baking powder and salt
Copyright 1996 Delta Food Group Aston, PA

### Baking Instructions

Heat Oven to temperature. Mix sugars, margarine and egg. Stir in flour, baking soda, and salt (dough will be stiff). Stir in nuts and chocolate chips. Drop dough by rounding teaspoonfuls about 2 inches apart onto ungreased cookie sheet. Bake 8-10 minutes until light brown. Centers will be soft. Cool slightly; remove from cookie sheet.

RECIPE 5
PRESSURE TREATED CELLULOSE IN
BASIC YELLOW CAKE

| | CALORIES/SERVING |
|---|---|
| ORIGINAL RECIPE | 95 |
| PRESSURE TREATED VERSION | 63 |

INGREDIENTS AND MEASUREMENTS

| | ORIGINAL | | REVISED |
|---|---|---|---|
| INGREDIENT | RECIPE | | RECIPE |
| Shortening | 190 | g | same |
| Sugar | 360 | g | same |
| Eggs | 4 | | same |
| Sifted cake flour | 312 | g | 234 g |
| PRESSURE TREATED CELLULOSE/901 | 0 | g | 78 g |
| Baking powder | 12.5 | g | same |
| Salt | 2.5 | g | same |
| Milk | 250 | ml | same |
| Almond extract | 5 | ml | same |
| Vanilla extract | 5 | ml | same |

SERVES: One 3-layer cake
Preparation Time: 15 Minutes
Elapsed Time: 1 Hours 30 Minutes
Bake Time: 20 to 25 Minutes
Oven Temp: 375° (F.)
Copyright 1996 Delta Food Group Aston, PA

### Baking Instructions

Cream shortening; gradually add sugar, beating well at medium speed of an electric mixer. Add eggs, one at a time, beating well after each addition.

Combine flour, baking powder, and salt; add to creamed mixture alternately with milk, beginning and ending with flour mixture. Mix after each addition. Stir in flavorings.

Pour batter into 3 greased and floured 9-inch round cakepans. Bake at 375 degrees for 20 to 25 minutes or until a wooden pick inserted in center comes out clean. Cool in pans 10 minutes; remove from pans, and let cool completely on wire racks. Frost as desired.

Copyright 1996 Delta Food Group

Aston, Pa.

In the above recipes the original recipe, made without the pressure treated dietary ingredient has a significantly higher caloric content. By substituting part of the flour or sugar content with pressure treated fiber the overall caloric content for the baked product can be significantly reduced.

The use of pressure treated fibers in accordance with the present invention in various baked or fried foods results in improved dietary functionality for the final end product by producing several key improvements:

Reduced caloric content for the end product due to increased loading of a dietary fiber ingredient.

Increased total dietary fiber content in the end product due to increased loading of an improved dietary fiber, possessing increased insoluble fiber values.

Reduced ability to absorb moisture in the end product, due to the incorporation of dietary fiber ingredients that exhibit lowered water-holding capacity, leading to longer shelf life.

Improved mouth feel, texture and taste perception.

Reduced oil absorption and retention properties in breaded coatings or fried batters means less fat absorbed, and therefore fewer calories for the end product.

These and other improvements are possible through the use of dietary fiber ingredients pressure modified in accordance with the present invention.

While it is obvious to anyone skilled in the art that there are several means of generating a pressure shock wave or abrupt pressure change the preferred embodiment of the apparatus is disclosed as merely the forerunner of similar devices.

While only a few fibers have been listed it should be obvious to one skilled in the art of food science that the present invention may be applied to a variety of dietary fibers.

We claim:

1. A process for modifying the properties of a particulate dietary fiber material comprising dispersing said particulate material in a liquid media, applying an abrupt pressure change to said particulate material in said liquid media, and recovering said modified fiber material.

2. The process of claim 1 wherein said abrupt pressure change is from about 0.8 to about 1.2 atm to greater than 13,000 psi to about 100,000 psi in about 0.1 to 0.2 sec.

3. The process of claim 1 further comprising drying said modified fiber.

4. The process of claim 3 further comprising subjecting said recovered fiber to mechanical action sufficient to reduce particulate agglomeration.

5. The process of claim 1 wherein said liquid media contains about 10 to about 25 percent by weight of said fiber material.

6. The process of claim 1 wherein said liquid media is subjected to said abrupt pressure change at a temperature of about 25 degrees centigrade.

7. The process of claim 3 wherein said modified fiber is dried at a temperature greater than 25 degrees centigrade.

8. The process of claim 7 wherein said modified fiber is dried at a temperature of about 70 degrees centigrade.

9. The process of claim 3 wherein said modified fiber is recovered by allowing suspended particles to settle and decanting the liquid media.

10. A process to reduce the water holding capacity and oil retention properties of dietary fibers selected from the group including dietary cellulose and wheat fibers, comprising preparing a suspension of said fibers in a liquid media, applying an abrupt pressure change greater than 13,000 psi to about 100,000 psi to said suspension and recovering a modified fiber having said reduced properties.

11. A process to increase the water holding capacity and oil retention properties of dietary fibers selected from the group including dietary soy, wheat bran, oat and oat hull fibers, comprising preparing a suspension of said fibers in a liquid media, applying an abrupt pressure change greater than 13,000 psi to about 100,000 psi to said suspension and recovering a modified fiber having said increased properties.

12. A process to prepare a dietary fiber material having water absorption properties that are resistant to change due to temperature increases comprising preparing a suspension of said fibers in a liquid media, applying an abrupt pressure change greater than 13,000 psi to about 100,000 psi to said suspension and recovering a modified fiber having said resistant properties.

13. A process to increase the total dietary fiber content of a dietary fiber material comprising preparing a suspension of said fibers in a liquid media, applying an abrupt pressure change greater than 13,000 psi to about 100,000 psi to said suspension and recovering a modified fiber having said resistant properties.

14. The process according to claim 1 wherein said particulate dietary fiber material is derived from the group consisting of apple fiber, bran fiber, fig powder, barley bran flour, barley four, high protein, barley fiber brewer's spent grains, oat bran, oat fiber barley, rice, malted germ, pea fiber, bleached corn fiber, powdered cellulose, carrageen gum cellulose gum, prunes, citrus fiber, rice bran, de-fatted cocoa, rice bran-stabilized, corn bran, rice fiber, corn fiber, cellulose fibers, sodium carboxymethyl cellulose, corn flour, soy fiber, corn husks, sugar beet fiber, dried cranberries, wheat bran de-fatted, wheat germ, wheat fiber, oat husks, wheat flour, peanut flour, microcrystalline cellulose, combinations of any number of the above fibers, blends of above fibers in a raw state with their pressure treated versions.

15. A modified dietary fiber made by the process according to any one of claims 1 to 14.
